(19) United States
(12) Patent Application Publication
(10) Pub. No.: US 2016/0146725 A1
(43) Pub. Date: May 26, 2016

(54) SYSTEM AND METHOD FOR SIGNATURE VERIFICATION

(71) Applicant: MICHAEL BORNSTEIN CBCS COMICS, BELLAIRE, TX (US)

(72) Inventor: MICHAEL BORNSTEIN, BELLAIRE, TX (US)

(21) Appl. No.: 14/637,892

(22) Filed: Mar. 4, 2015

Related U.S. Application Data
(63) Continuation-in-part of application No. 14/628,390, filed on Feb. 23, 2015.
(60) Provisional application No. 62/090,259, filed on Dec. 10, 2014.
(60) Provisional application No. 62/082,914, filed on Nov. 21, 2014.

(51) Int. Cl. G01N 21/27; G01B 11/22

(52) U.S. Cl. CPC G01N 21/27; G01B 11/22; G01N 2201/06113

(57) ABSTRACT

A system and method for verifying a signature on a document, are disclosed, the method including but not limited to generating on a verification processor a characteristic signature map for the signature on the document; correlating on the verification processor the characteristic signature map for the signature with a reference characteristic signature map for the signature; and generating on the verification processor a confidence verification score for the signature based on the correlating the characteristic signature map. A system is disclosed for practicing the invention.

### CROSS REFERENCE TO RELATED APPLICATIONS

This patent application bases priority from the following three patent applications: U.S. Provisional patent application entitled A System and Method for Encapsulating a Comic Book By Michael Bornstein Ser. No. 62/090,259 filed on Dec. 10, 2014; U.S. Provisional patent application entitled A System and Method for Encapsulating a Comic Book By Michael Bornstein Ser. No. 62/082,914 filed on Nov. 21, 2014; and U.S. patent application Ser. No. 14/628,390 filed on Feb. 23, 2015 entitled A System and Method for Encapsulating a Comic Book By Michael Bornstein, all three of which are incorporated by reference herein in their entirety.

### BACKGROUND OF THE INVENTION

Comic book collecting has rapidly grown from nothing more than a child's hobby to a substantial section of the collectables market. Oftentimes a comic book is signed by an artist. There is a need to verify a signature to determine that the signature is what it is purported to be.

### SUMMARY OF THE INVENTION

A system and method for verifying a signature on a document, are disclosed, the method including but not limited to generating on a verification processor a characteristic signature map for the signature on the document; correlating on the verification processor the characteristic signature map for the signature with a reference characteristic signature map for the signature; and generating on the verification processor a confidence verification score for the signature based on the correlating the characteristic signature map. A system is disclosed for practicing the invention.

### BRIEF DESCRIPTION OF THE DRAWINGS

The Figures are provided to show examples of different embodiments of the invention.

FIG. 1 is schematic representation of an illustrative embodiment of the verification system;

FIG. 2 is a schematic representation of an illustrative embodiment of the invention depicting a characteristic signature mapping generation system;

FIG. 3 is a schematic representation of an illustrative embodiment of the invention depicting a characteristic signature mapping;

FIG. 4 is a schematic representation of an illustrative embodiment of the invention depicting a spectrometer;

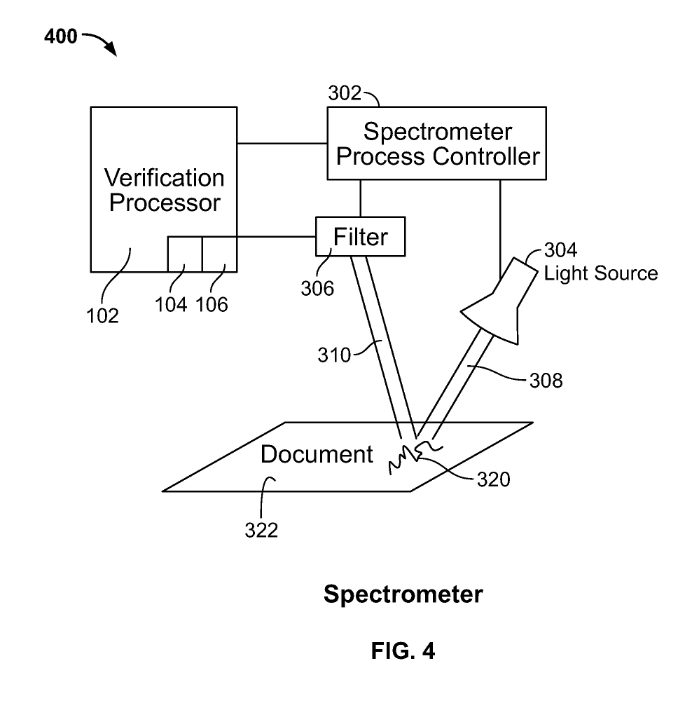

FIG. 5 is a schematic representation of an illustrative embodiment of the invention depicting a depth of impression mapping generation system;

FIG. 6 is a schematic representation of an illustrative embodiment of the invention showing characteristic signature map verification;

FIG. 7 is flow chart representation of an illustrative embodiment of the showing light spectra verification;

FIG. 8 is a flow chart representation of an illustrative embodiment of the invention depicting a depth of impression verification for a signature;

FIG. 9 is a schematic representation of an illustrative embodiment of the invention depicting sweat print verification;

### DETAILED DESCRIPTION OF THE INVENTION

Collectable comic books have become rare and expensive, exceeding $100,000 in value. The collectors take their “hobby” very seriously. Thus, grading and authentication of the comic books becomes essential to determine a reliable value for a particular comic book. The primary reason to grade a comic is that there is a direct correlation between the condition of the comic book and the value of the comic book. Of course, the comic book grade has more value when a buyer has confidence that the comic book or document is what is held out to be. Comic books have become so valuable that fraudulent representation of counterfeit comic books is a risk associated with purchase of an expensive comic book. Also, when the comic book is autographed, it is more valuable when the signature is verified to be what it is held out to be.

In a particular embodiment of the invention, a method for verifying a signature on a host document is disclosed, the method including but not limited to generating on a verification processor a characteristic signature map for the signature on the host document; correlating on the verification processor the characteristic signature map for the signature with a reference characteristic signature map for the signature; and generating on the verification processor a confidence verification score for the signature based on the correlating the characteristic signature map.

In another particular embodiment of the invention, the method further includes but is not limited to irradiating the signature on the host document with a light source; collecting in the verification processor, light spectra from the signature; correlating on the verification processor, the light spectra from signature with a reference spectrum for the signature; and generating on the verification processor, a confidence verification score for the signature based on the correlating light spectra.

In another particular embodiment of the invention, the method further includes but is not limited to generating a depth of impression map for the signature on the host document; correlating on the verification processor the depth of impression map for the signature with a reference depth of impression map for a known authentic version of the signature; and generating on the verification processor a confidence verification score for the signature based on the correlating the depth of impression map for the signature with a reference depth of impression map for the signature. In another particular embodiment, the method further includes but is not limited to generating a chemical sweat print for the signature; correlating the chemical sweat print for the signature with a reference chemical sweat print for the signature; and generating a confidence verification score for the signature based on the correlating the chemical sweat print for the signature with a reference chemical sweat print for the signature.

In another particular embodiment of the invention, the method further includes but is not limited to irradiating the document with the light source; collecting a light spectra from the document; correlating the light spectra to a reference spectrum for the document with a reference spectra for the document; and generating a confidence verification score for the document based on the correlating the light spectra to a reference spectrum for the document. In another particular embodiment of the invention, the light source is an infrared light source and the spectra are a reflectance infrared spectra.

In another particular embodiment of the invention, the verification processor further comprises a neural network, the method further including but not limited to adjusting weights in the neural network based on at least one of, the correlating the light spectra, correlating the characteristic signature map, the depth of impression map and the chemical sweat print. In another particular embodiment of the invention, the method further includes but is not limited to generating a confidence verification score for the signature based on the correlating the light spectra, correlating the characteristic signature map, the depth of impression map and the chemical sweat print. In another particular embodiment of the invention, the method further includes but is not limited to generating a quick scan code for the confidence verification score; and placing the quick scan code on a package for the document. In another particular embodiment of the invention, the spectra are fluorescence infrared spectra

In another particular embodiment of the invention, a system for verifying a signature on a document is disclosed, the system including but not limited to a verification processor in data communication with a non-transitory computer readable medium verify a signature on a document, the computer readable medium containing a computer program comprising: instructions to generate a characteristic signature map for the signature on the document, instructions to correlate on the verification processor the characteristic signature map for the signature with a reference characteristic signature map for the signature; and instructions to generate on the verification processor a confidence verification score for the signature based on the correlating the characteristic signature map.

In another particular embodiment of the invention, a system for verifying a signature on a document is disclosed, the system including but not limited to a light source that irradiates the signature on the document; a spectrometer that collects a light spectra from the signature based on the irradiated light source, the computer program further comprising instructions to irradiate the document and correlate the light spectra from signature with reference spectra for the signature; and instructions to generate on the verification processor, a confidence verification score for the signature based on the correlating light spectra.

In another particular embodiment, a system for verifying a signature on a document is disclosed, the system including but not limited to a source that generates a depth of impression map for the signature; the computer program further comprising: instructions to generate the depth of impression map for the signature; instructions to correlate on the verification processor the depth of impression map for the signature with a reference depth of impression map for the signature; and instructions to generate on the verification processor a confidence verification score for the signature based on the correlating the depth of impression map for the signature with a reference depth of impression map for the signature.

In another particular embodiment, a system for verifying a signature on a document is disclosed, the system including but not limited to a source that generates a chemical sweat print for the document adjacent the signature; the computer program further comprising: instructions to generate a chemical sweat print for the document adjacent the signature; instructions to correlate the chemical sweat print for the signature with a reference chemical sweat print for the signature; and instructions to generate a confidence verification score for the signature based on the correlating the chemical sweat print for the signature with a reference chemical sweat print for the signature.

In another particular embodiment of the a system for verifying a signature on a document is disclosed, the system including but not limited to instructions to irradiate the document with the light source; instructions to collect a light spectra from the document based on light from the light source incident on the document; instructions to correlate the light spectra to a reference spectrum for the document with a reference spectra for the document; and instructions to generate a confidence verification score for the document based on the correlating the light spectra to a reference spectrum for the document.

In another particular embodiment, a system for verifying a signature on a document is disclosed, the system including but not limited to wherein the light source is an infrared light source and the spectra are a reflectance infrared spectra. In another particular embodiment of the system, the verification processor further includes but is not limited to a neural network, the computer program further including but not limited to: instructions to adjust weights in the neural network based on at least one of, the correlated light spectra, the correlated characteristic signature map, the correlated depth of impression map and the correlated chemical sweat print. In another particular embodiment of the system for verifying a signature on a document, the system further includes but not limited to instructions to generate a confidence verification score for the signature based on the correlating the light spectra, the correlated characteristic signature map, the correlated depth of impression map and the correlated chemical sweat print.

In another particular embodiment of the system for verifying a signature on a document is disclosed, the computer program further includes but not limited to instructions to generate a quick scan code for the confidence verification score; and instructions to place the quick scan code on a package for the document. In another particular embodiment, the system for verifying a signature on a document is disclosed wherein the spectra are fluorescence infrared spectra.

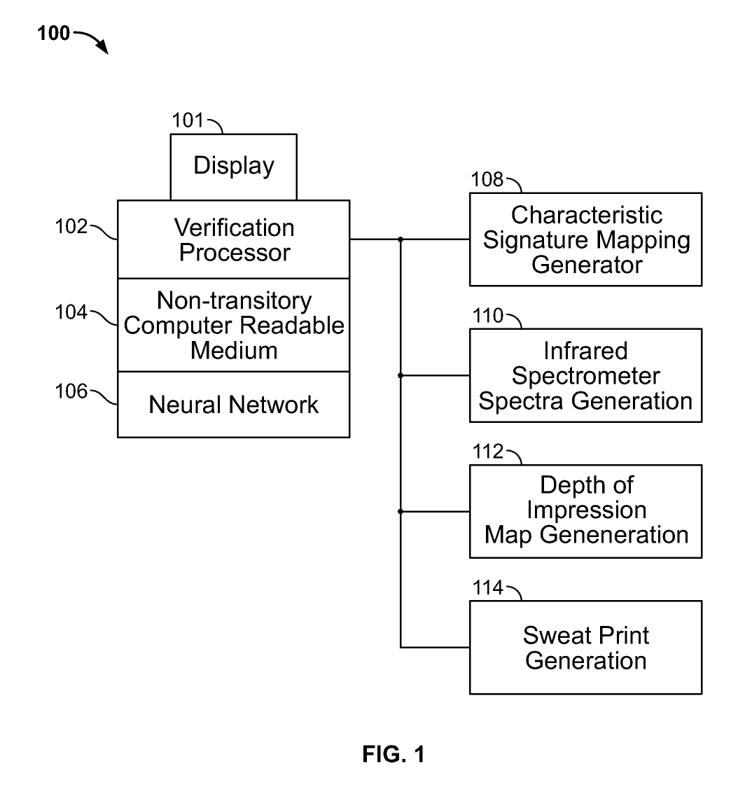

Turning now to FIG. 1, as shown in FIG. 1, an illustrative embodiment of the invention 100 is schematically depicted. In a particular embodiment, the system includes but is not limited to a verification processor 102, a verification processor display/interface 101 for a user interface to the verification processor, a non-transitory computer readable medium 104, a neural network 106, a characteristic signature mapping generator 108, an infrared spectrometer 110, a depth of impression generator 112 and a sweat print generator 114. In a particular illustrative embodiment of the invention, the verification processor reads the characteristic signature map. The neural network correlates the characteristic signature map with a data base of a collection of reference characteristic signature maps stored in the non-transitory computer readable medium. The neural network generates a confidence score based on the degree of correlation between the characteristic signature map generated from the signature and a best fitting reference characteristic signature map from the non-transitory computer readable medium.

In a particular illustrative embodiment of the invention, the characteristic signature mapping generator produces a generated characteristic signature map for a signature undergoing a signature verification process. The verification processor then correlates the generated character signature map of the signature undergoing the verification process with a bank of reference character signature maps stored in the computer readable medium. The degree of correlation (also referred to herein as a confidence score) with a particular reference character signature mapping is an indication of confidence in the verification that the signature is the signature of the artist associated with the reference character signature mapping, based on the character signature mapping. The maximum degree of confidence based on the reference character signature mapping is about 100%. In one embodiment, authenticated and witnessed signatures of artists are used to generate the reference character signature mappings to which a signature on a host document is correlated. In another embodiment the neural network correlates the best available signatures for an artist to generate an estimate of the reference character signature. Verifications of the signature under investigation have a reduced degree of confidence when the verification is based on the estimate of the reference character signature. The maximum degree of confidence based on the estimated reference character signature mapping is about 90%.

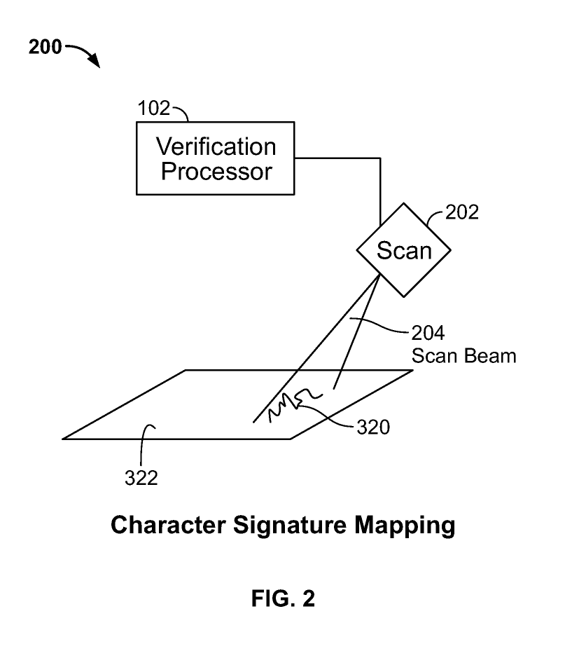

As Shown in FIG. 2, the verification processor 102 scans the host document 322 and the signature 320 using scanner 202 analyzing scan beam 204. The verification processor performs a close, forensic examination of every component and letter of the autograph, paying close attention to characteristics of signature flow, direction, style, spontaneity, letter angle, and spacing, Shaky, hesitant, or forced strokes are often red flags for forgeries. Once an autograph is deemed genuine by the forensic examination, the host document image, usually a comic book image, is saved. Next, the signature is converted into a Characteristic Signature Map (CSM). The CSM will then be entered into the database to protect the comic book from possible forgery attempts.

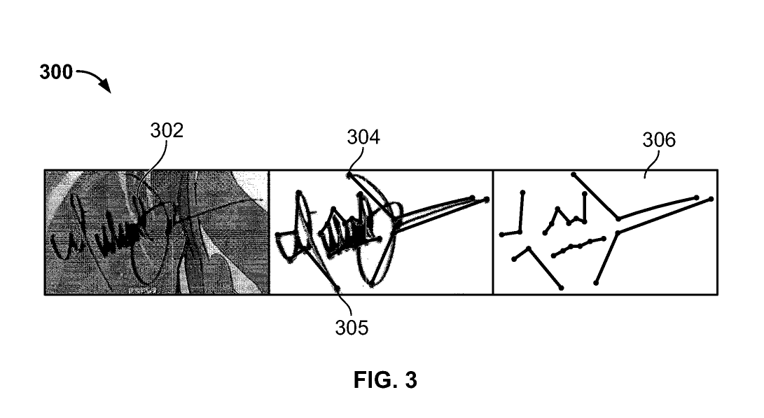

As shown in FIG. 1, FIG. 2 and FIG. 3, the verification processor directs the character signature mapping generator 108 to scan the signature 302 and convert the scanned signature into a characteristic signature map (CSM) 306 including but not limited to a number of upper points 304 and lower points 305. This CSM is then compared to the CSM's of genuine signatures from the reference CSM Signature Database stored in the non-transitory computer readable medium. This technique is used in both the side by side comparison of signatures and in authenticating the actual signature on the host document using the verification processor system.

Verified document and signatures receive documentation and certificates that are marked with a verification logo using an invisible watermark ink that becomes visible in deep UV light (black light). The documentation and certificates stored in the non-transitory computer readable medium and are accessed by a quick response code generated for the verification of the signature and document. In another particular embodiment, the quick response code (QRC) is applied to a case encapsulating the host document. In another particular embodiment, the verification logo is applied to a case encapsulating the host document. This feature ensures positive identification and authentication of documents, and reduces the chances of anyone being able to reproduce or forge a serialized collectible. In addition to the invisible watermark, items are granted their own serialized sticker with a QRC. The QRC is unique to a single comic book and can be entered via a smart phone to access a website to the verification processor or directly to the verification processor to verify authentication and access the documentation and certificates. The QRC can be scanned by any smart phone to access the authentication and access the documentation and certificates. Scanning any QRC takes a person directly to a link that proves authentication, shows detailed information about the signature, and displays the current owner of the autographed comic book. The QRC is tamper evident. If removed, the QRC will become damaged. In another particular embodiment, the QRC is placed on the package and on an end cap for the package so that removal of the end cap indicates damage to the matching QRC on the package.

If a signature on an item reads as forgery, the verification process immediately halts the authentication process and writes notes in the computer readable medium and to the verification processor display device explaining, in detail, why the verification processor lacks confidence in the authenticity of the signature. A message such as, “sample does no match reference sample” will be displayed to the display 101 on the verification processor.

The single most powerful effect of having documentation of authenticity is that it allows a comic book to be treated as property, similar to a car title. This paperwork may become admissible in court as forensics proof when fraud is attempted against the holder of the authenticated item. Insurance can be attached to the item after authentication, and, in the event of burglary or fraud, the documentation helps to file for an insurance claim to recoup losses.

In a particular embodiment, an infrared spectrometer 110 is used to gather infrared spectra from a signature under investigation. In a particular illustrative embodiment, the infrared spectra is used determine the type of ink used in the signature under investigation, usually a signature on a comic book as a host document. In another particular embodiment, the spectrometer is disclosed as a focused infrared beam as shown in FIG. 3. As shown in FIG. 3, in a particular illustrative embodiment 300 of the invention, a light source 304 shines light on a host document 322 and a signature 320 appearing on the host document. In this example, the host document is a comic book. In a particular embodiment, the light beam is 10 microns wide and can isolate sections of the signature or the host document. The light width is adjustable for broad scan areas for verifying larger areas such as a section of a comic book cover. The light beam 308 is incident upon a targeted area on the signature or the host document, or both. The width, position and frequency spectrum of the light beam 308 is adjustable by the verification processor by issuing a width, position and frequency spectrum command to the spectrometer process controller 302. A filter 306 selects a spectra of interest and selectively processes light 310 within the spectra of interest after the light beam 308 interacts the sections of the signature or the host document. The filtered spectra are read by the verification processor and correlated with the reference spectra to help determine the authenticity of which the signature and the host document. In another particular embodiment, the light source frequency spectrum and the filter are varied to perform infrared (IR), ultraviolet (UV), near-infrared (NIR) and visible light spectroscopy on a host document and signature. The spectrometer light source and filter spectrum (spectra) are varied to perform different spectrometric analyses including but not limited to reflectance spectroscopy, NIR spectroscopy, luminance spectroscopy and attenuated reflectance spectroscopy. In another particular embodiment, the verification processor controls the spectrometer and selects the light spectra and filter selected for the document exposed to the light source to perform any available, new or yet to developed spectroscopy technique.

With infrared light, the spectrometer and verification processor can determine you whether a signature on a document is a forgery or whether the host document on which the signature is written is counterfeit. The spectrometer and verification processor examine a swath of color on a comic book cover and determine the publisher and age of the comic book. In a particular embodiment, the spectrometer includes but is not limited to an electron synchrotron that's been optimized for the production of x-ray and ultraviolet light but also generates intense beams of photons in the infrared (IR) spectrum. The verification processor applies IR spectromicroscopy to characterize a variety of inks on paper with unprecedented sensitivity. The verification processor and IR spectromicroscopy spectrometer uses these IR beams to obtain chemical “sweatprints” that may be every bit as unique and ubiquitous as physical fingerprints.

In a particular embodiment of the spectrometer, a width and frequency adjustable infrared beam is used to focus IR light down to about a 10 micron spot size. The 10 micron beam width allows for extremely small sample sizes and nondestructive testing without extensive preparation of the sample under test. The 10 micron IR beam only raises the temperature of the sample by a fraction of a degree. The 10 micron IR beam does not break chemical bonds in the ink or host document and does not change the chemical formula for the sample. The 10 micron use small sample sizes also reveal details that would otherwise be missed using larger sample sizes employed by other conventional IR techniques.

In a particular embodiment, the spectrometer uses the IR beam along with synchrotron-based IR spectromicroscopy IR data on ink in a signature or host document to identify the possible origins of the document, verify that the document is as old as it is claimed to be, and check if the same ink is used throughout the document. In a particular embodiment, synchrotron-based IR spectromicroscopy IR uses photons at wavelengths of 2.5 to 25 microns are used to characterize ink samples. The synchrotron-based IR spectromicroscopy light beam is sufficiently intense to enable making rapid and direct spectromicroscopic measurements of the inks without having to chemically separate them from the paper. Because of the high spatial resolution, the spectrometer is able to create IR spectroscopic profiles of ink and paper interfaces so they could determine where one ink ended and another began in the same signature or line of print.

IR spectromicroscopy is also used to identify chemical sweatprints. When you touch something you leave behind a fingerprint and a minute residue of chemicals—proteins, salts, and fatty acids—whose proportions to one another vary among individuals and may also be used to identify a signatory to a document.

All of the oil metabolites in sweat left in a sweatprint have an IR spectrum. The spectrometer can analyze a sweatprint sample less than 10 microns across. An IR spectromicroscopic profile of a sweatprint might also reveal the age and gender of the person leaving the sweat and possibly even identify when the sweat was deposited, if the appropriate chemical markers can be observed in the IR spectrum.

In another illustrative embodiment, the spectrometer is a Fourier transform infrared spectroscopy (FT-IR). FT-IR microspectroscopy extends the use of traditional FT-IR by allowing for quick, nondestructive analysis of samples approaching 10 microns. In a particular embodiment, the spectrometer includes but is not limited to a Thermo Scientific™ Nicolet™ iN™10 infrared microscope that is a powerful combination of an optical microscope with an integrated FT-IR. The Nicolet iN10 provides an analytical tool to visually and chemically analyze inks, and paints. The Thermo Scientific™ OMNIC™ Picta™ software makes operation simple and quick for reflection, transmission, and ATR (attenuated total reflectance) analysis.

In another embodiment, the infrared spectrometer is used to generate infrared spectra for a host document on which the signature undergoing the verification process appears. In another embodiment, a bank of spectra and images for a group of reference comic book covers are stored in the computer readable medium and a bank of comic book content spectra and images are stored in the computer readable medium. A database stored in the computer readable medium associates each character reference signature with an artist name and the comic book titles with which the artist is associated. The artist may also be a writer or may be a writer instead of a graphic artist, such as a graphic artist that illustrated the comic book. Thus, the artist signature can be verified and the comic book cover can be verified using infrared spectra generated from the host document.

In a particular embodiment, a sweat print is generated from the infrared spectra for the host cover for signature undergoing the verification process. In a particular embodiment, infrared spectra for a sample from the document or from the signature is as small as a ridge on a finger print is examined by the infrared spectrometer and verification processor using the spectra generated by the infrared spectrometer to determine chemical composition of a sweat print appearing on the host over. The chemical content of a sweat print appearing on the host cover is generated from the infrared spectra obtained for the host cover. The spectra for the sweat print on the host document is correlated with a reference sweat print associated with the artist identified in the character signature mapping correlation. In another particular embodiment the spectra for the ink in the signature is analyzed using Video Spectral Comparison to detect the appearance of different inks in a signature.

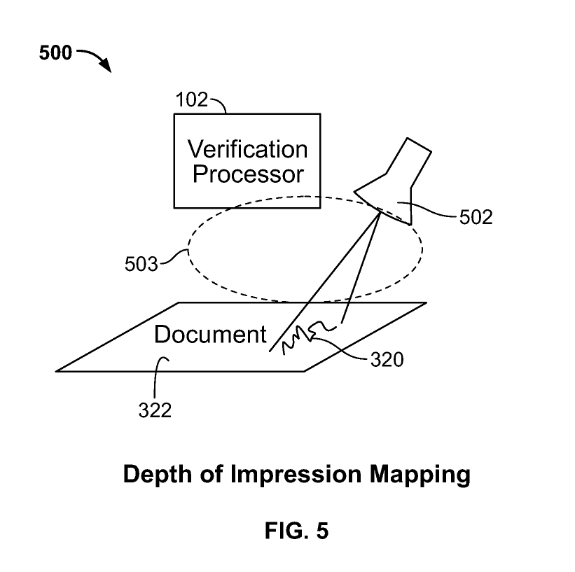

Turning now to FIG. 5, in a particular illustrative embodiment, a pressure and depth of impression map is generated for a signature undergoing the verification process. As shown in FIG. 5, a signature 320 and host document 322 are examined by scanner 502 to determine a pressure and depth of impression map for the signature 320. In a particular embodiment of the invention, the scanner moves around path 503 to examine the signature from different angles and facilitate generating the depth of impression map for the signature. In another particular embodiment, the depth of impression map is an Electro-static Detection Apparatus. In another particular embodiment, the depth of impression map is a laser impression depth profile having a 1 micron depth resolution.

This generated pressure and depth of impression maps are correlated with a reference pressure and reference depth of impression map for a reference signature for the artist identified by correlation of the signature to the characteristic signature mapping. The degree of correlation between the generated pressure and depth of impression map and the reference pressure and depth of impression map for a reference signature for the artist identified by the characteristic signature mapping is the degree of confidence that the signature is authentic and not a forgery. The axial pressure exerted on the document by the signatory's pen during the signature is estimated from the width of the pen stroke on the document. The axial pressure exerted on the document by the signatory's pen during the signature is estimated from the depth of the impression made on the document by the signature.

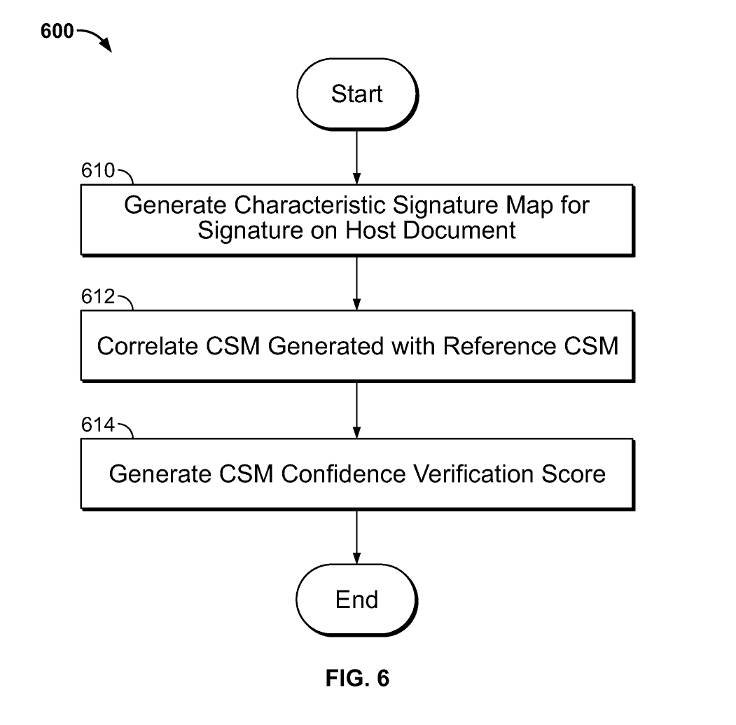

Turning now to FIG. 6, FIG. 6 is a flow chart representation of a particular embodiment 600 of the present invention. As shown in FIG. 6, in a particular embodiment, the verification process generates a characteristic signature mapping for a signature on a host document at 610. The process then correlates the generated characteristic signature mapping from block 610 with a reference characteristic signature mapping for a known to be authentic reference signature at 612. The verification process then generates a characteristic signature mapping confidence verification score.

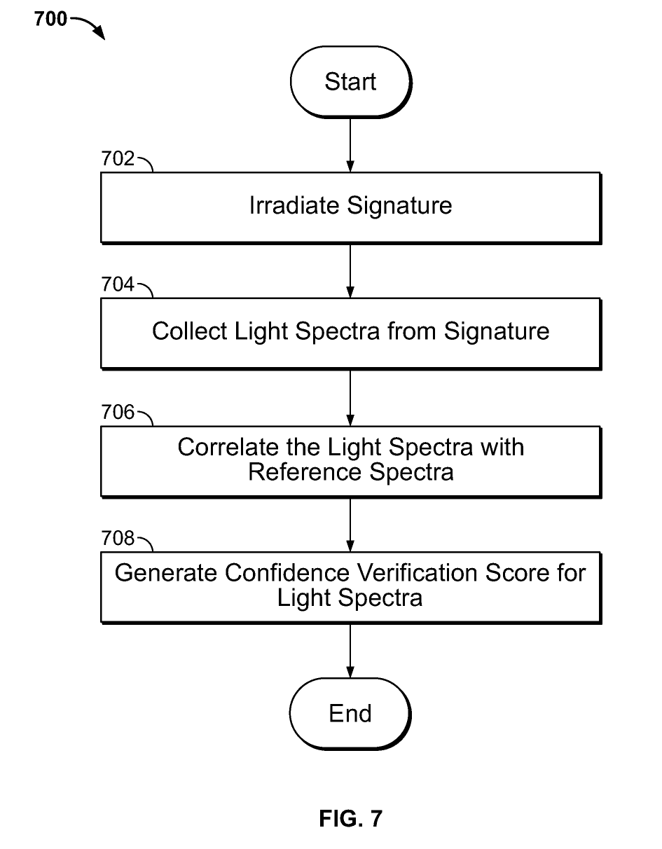

Turning now to FIG. 7, as shown in FIG. 7, in a particular embodiment, the verification processor commands the light source on the spectrometer to irradiate (illuminate) the signature with light at 702. At 704 the verification system collects light spectra from the irradiated signature. At 706 the verification system correlates the light spectra from the signature with a reference spectra for a known to be authentic signature. At 708 the verification system generates a confidence verification score for the generated light spectra.

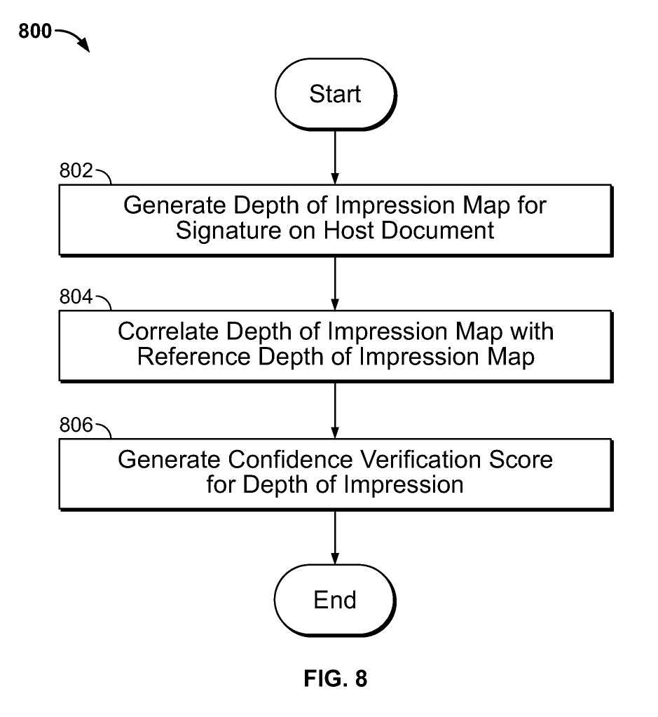

Turning now to FIG. 8, as shown in FIG. 8, in a particular illustrative embodiment, the verification processor commands a depth of penetration mapping system to generate a pressure and depth of penetration mapping for a signature on a host document 802. The combination of the pressure mapping and the depth of penetration mapping generate three dimensional mapping of the axial pressure that a pen made during the signature. At 804 the verification system correlates the depth of impression mapping and the pressure mapping from the signature with a reference depth of impression mapping and the pressure mapping for a known to be authentic signature. At 806 the verification system generates a confidence verification score for the generated depth of impression mapping and the pressure mapping.

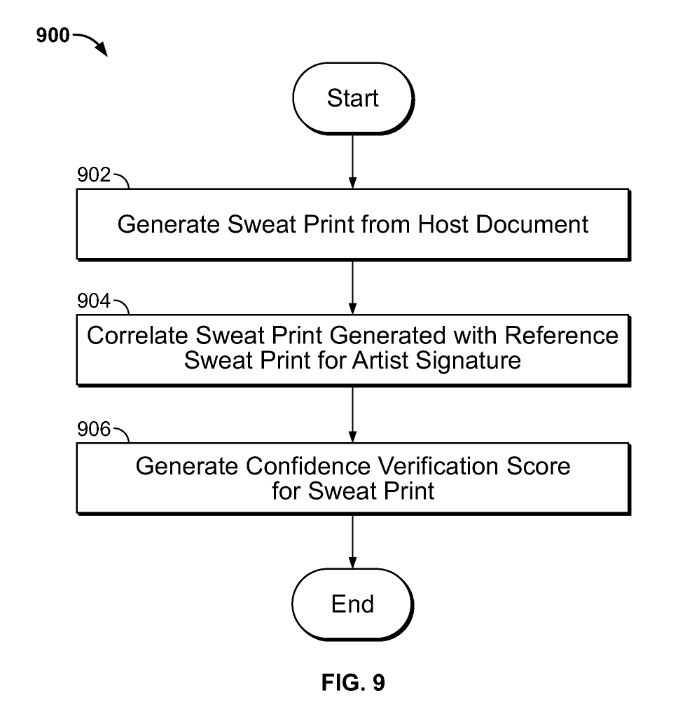

Turning now to FIG. 9, as shown in FIG. 9, in a particular illustrative embodiment, the verification processor commands the spectrometer to generate a sweat print for a host document 902. At 904 the verification system elates the sweat print from the host document with a reference sweat print for a known to be authentic signature. At 906 the verification system generates a confidence verification score for the generated depth of impression mapping and the pressure mapping.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for verifying a signature on a document, the method comprising:
generating on a verification processor a characteristic signature map for the signature on the document;
correlating on the verification processor the characteristic signature map for the signature with a reference characteristic signature map for the signature; and
generating on the verification processor a confidence verification score for the signature based on the correlating the characteristic signature map.

2. The method of claim 1, the method further comprising:
irradiating the signature on the document with a light source;
collecting in the verification processor, a light spectra from the signature;
correlating on the verification processor, the light spectra from signature with a reference spectra for the signature; and
generating on the verification processor, a confidence verification score for the signature based on the correlating light spectra.

3. The method of claim 2, the method further comprising:
generating a depth of impression map for the signature;
correlating on the verification processor the depth of impression map for the signature with a reference depth of impression map for the signature; and
generating on the verification processor a confidence verification score for the signature based on the correlating the depth of impression map for the signature with a reference depth of impression map for the signature.

4. The method of claim 3, the method further comprising:
generating a chemical sweat print for the signature;
correlating the chemical sweat print for the signature with a reference chemical sweat print for the signature; and
generating a confidence verification score for the signature based on the correlating the chemical sweat print for the signature with a reference chemical sweat print for the signature.

5. The method of claim 4, the method further comprising:
irradiating the document with the light source;
collecting a light spectra from the document;
correlating the light spectra to a reference spectrum for the document with a reference spectra for the document; and
generating a confidence verification score for the document based on the correlating the light spectra to a reference spectrum for the document.

6. The method of claim 5, wherein the light source is an infrared light source and the spectra are a reflectance infrared spectra.

7. The method of claim 5, wherein the verification processor further comprises a neural network, the method further comprising:
adjusting weights in the neural network based on at least one of, the correlating the light spectra, correlating the characteristic signature map, the depth of impression map and the chemical sweat print.

8. The method of claim 5, the method further comprising:
generating a confidence verification score for the signature based on the correlating the light spectra, correlating the characteristic signature map, the depth of impression map and the chemical sweat print.

9. The method of claim 5, the method further comprising:
generating a quick scan code for the confidence verification score; and
placing the quick scan code on a package for the document.

10. The method of claim 2, wherein the spectra are fluorescence infrared spectra

11. A system for verifying a signature on a document, the system comprising:
a verification processor in data communication with a non-transitory computer readable medium verify a signature on a document, the computer readable medium containing a computer program comprising:
instructions to generate a characteristic signature map for the signature on the document, instructions to correlate on the verification processor the characteristic signature map for the signature with a reference characteristic signature map for the signature; and
instructions to generate on the verification processor a confidence verification score for the signature based on the correlating the characteristic signature map.

12. The system of claim 11, the system further comprising:
a light source that irradiates the signature on the document;
a spectrometer that collects a light spectra from the signature based on the irradiated light source,
the computer program further comprising instructions to irradiate the document and correlate the light spectra from signature with reference spectra for the signature; and
instructions to generate on the verification processor, a confidence verification score for the signature based on the correlating light spectra.

13. The system of claim 12, the system further comprising:
a source that generates a depth of impression map for the signature;
the computer program further comprising:
instructions to generate the depth of impression map for the signature;
instructions to correlate on the verification processor the depth of impression map for the signature with a reference depth of impression map for the signature; and
instructions to generate on the verification processor a confidence verification score for the signature based on the correlating the depth of impression map for the signature with a reference depth of impression map for the signature.

14. The system of claim 3, the system further comprising:
a source that generates a chemical sweat print for the document adjacent the signature;
the computer program further comprising:
instructions to generate a chemical sweat print for the document adjacent the signature;
instructions to correlate the chemical sweat print for the signature with a reference chemical sweat print for the signature; and
instructions to generate a confidence verification score for the signature based on the correlating the chemical sweat print for the signature with a reference chemical sweat print for the signature.

15. The system of claim 14, the system further comprising:
instructions to irradiate the document with the light source;
instructions to collect a light spectra from the document based on light from the light source incident on the document;
instructions to correlate the light spectra to a reference spectrum for the document with a reference spectra for the document; and
instructions to generate a confidence verification score for the document based on the correlating the light spectra to a reference spectrum for the document.

16. The method of claim 15, wherein the light source is an infrared light source and the spectra are a reflectance infrared spectra.

17. The method of claim 15, wherein the verification processor further comprises a neural network, the method further comprising:
instructions to adjust weights in the neural network based on at least one of, the correlating the light spectra, correlating the characteristic signature map, the depth of impression map and the chemical sweat print.

18. The method of claim 15, the system further comprising:
instructions to generate a confidence verification score for the signature based on the correlating the light spectra, correlating the characteristic signature map, the depth of impression map and the chemical sweat print.

19. The system of claim 15, the computer program further comprising:
instructions to generate a quick scan code for the confidence verification score; and
instructions to place the quick scan code on a package for the document.

20. The system of claim 15, wherein the spectra are fluorescence infrared spectra.
